(19) United States
(12) Patent Application Publication
(10) Pub. No.: US 2010/0049652 A1
(43) Pub. Date: Feb. 25, 2010

(54) Automated System For Generating Philanthropic Donations Using Credit or Debit Cards

(76) Inventor: Dale Joan Young, Bedford Hills, NY (US)

Correspondence Address: WILSON DANIEL SWAYZE, JR., 3804 CLEARWATER CT., PLANO, TX, 75025, US

(21) Appl. No.: 12/545,847

(22) Filed: Aug. 23, 2009

Related U.S. Application Data
(60) Provisional application No. 61/091,393, filed on Aug. 24, 2008.

(51) Int. Cl. G06Q 40/00; G06Q 20/00; G06Q 50/00

(52) U.S. Cl. 705/39

(57) ABSTRACT

A method for using a credit or debit card for making a donation to a charity, may include the steps of selecting a charity for donations, selecting an amount for the donation based upon a purchase using the credit card, charging the credit card for the donation when the purchases made. The step of selecting of the amount may include selecting a fixed percentage of the purchase price using the credit card, and the step of selecting the amount may include the step of selecting of selecting a one time donation using a credit or debit card, or a fixed amount for certain types of transactions. The fixed percentage may be a fixed percentage of the purchase price, and the amount of donation may be based on the type of purchase with the credit card. The amount of donation may vary based upon the type of purchase with a credit or debit card.

### PRIORITY

The present invention claims priority under 35 USC section 119 based upon the provisional application 61/091,393 which was filed on Aug. 24, 2008.

### BACKGROUND OF THE INVENTION

Currently, people make donations to charities by either using a credit or debit card or by writing a check or by giving cash directly to the charity. They may do so online, by phone or by snail mail. They may also elect to have a certain amount deducted from their checking account or credit or debit cards at preset intervals. Also, in lieu of obtaining frequent flier miles or other benefits, credit or debit card users might elect to use a vanity card, whereby a specific charity benefits by receiving a small contribution for each purchase. In this case, the donation is made by the card company and any tax deductible benefits are unavailable to the purchaser. In addition, if one wishes to make donations to multiple charities in this manner, he would require multiple cards, assuming of course, that the organization he wants to support has a vanity card tied to it.

There are many websites that make contributions to various charities by donating a percentage of the proceeds from purchased goods to either a charity that the vender is selecting, or by allowing a credit or debit card user to select one of several charities for donations to be made based upon their purchases. In all cases, the donations come from the vendor. Under these circumstances, the credit or debit card user cannot receive a benefit such as a tax deduction.

Some sites ask purchasers if they would like to make a donation to a particular charity for a preset amount. In these instances, the purchaser selects neither the charity nor the amount to be donated.

There are several companies that donate all the profits, or a percentage of their profits to a given charity when a purchase of a particular item is made.

There are also stores where people are asked to make donations after purchases utilizing various displays.

Several years ago, there was a program where airlines asked their customers to donate the change that they were carrying with them for a given charity.

In schools, there have been fundraising drives where students collect as much money as they can for specific charities. With these types of fundraisings, it is difficult to maintain sufficient receipts in order to satisfy the Internal Revenue Service. Consequently, the donor may not receive a benefit from these donations.

A number of organizations exist for the purpose of charitable and/or non-profit functions, including organizations which qualify as charitable organizations under U.S. Internal Revenue Service Regulation 501(c)(3). Not uncommonly, such organizations find that there are a number of costs associated with receiving and handling donations. One cost involves the labor or man-power costs associated with soliciting and/or receiving such donations. Many charitable organizations employ or hire individuals or organizations for the purpose of soliciting funds, attracting potential donors and the like. Because there are often costs associated with such employees or organizations (including wages, salaries or commissions and/or costs of advertising services or materials, and/or costs of mailings for solicitations of funds) a certain portion of the funds received or collected by a charitable organization, which might otherwise be available for the organizations' charitable functions, must instead be expended for costs associated with attracting or receiving donations.

Accordingly, it would be useful to provide an apparatus and method for donation transactions which reduces man-power requirements and/or costs associated with at least some donation transactions.

Another cost typically associated with or born by charitable organizations is the cost of handling the donated funds. In many situations, donations take the form of coins, currency, and/or negotiable instruments such as personal checks. In situations where the charitable organization receives a relatively large number of donations in relatively small amounts, the costs associated with handling such coins, cash or checks, (such as costs of counting and/or rolling or packaging coins, counting cash and/or checks, and depositing these items in a financial institution) further depletes funds of the charitable organization.

Accordingly, it would be useful to provide an apparatus or method which reduces the cost, to charitable organizations, associated with handling and/or bank deposits for donation transactions.

Yet another cost sometimes associated with charitable transactions is the cost associated with providing receipts to donors, particularly receipts of a type that may be used by donors in calculating taxes or documenting tax returns.

Accordingly, it would be useful to provide an apparatus or method which reduces the cost, to charitable organizations, associated with providing donation receipts for donation transactions. (n.b. charitable organizations would have to provide receipts in excess of certain amounts.)

Donors to charitable organizations are sometimes solicited for donations in situations where the donors are presented with a single choice: to donate or not to donate to a single, particular charitable organization. Accordingly, it would be useful to provide an apparatus and method in which potential donors are presented with a number of different options for the receipt of their donation(s).

In a number of situations, a person wishing to make a donation to a particular charitable institution is required to either be in possession of a donation form and/or an address and/or a phone number of the charitable institution or other information so that the donation may be transmitted to the correct recipient. also, donors often must bear the cost of postage or telephone calls in order to make a donation. Accordingly, it would be useful to provide a method or apparatus to permit a donor, to readily donate to a desired organization without the need to know the organization's address, without the need to possess a donation form and without the need to expend funds on postage and/or telephone calls to make the donation.

U.S. Pat. No. 5,466,919 discloses a credit/charge card system enabling purchasers to contribute to selected charities. This invention allows people to preselect charities to receive donations when credit cards are used, but it doesn't give users the option of donating a particular % with each purchase. In addition, in this system the charity(ies) is (are) identified on a magnetic strip. Also, this system doesn't allow people who are undecided about which charities to benefit, to have one selected for them. Nor does it have a link for information about various charities. If the credit/charge card user decides to donate money to a different charity, he will need to get a new credit/charge card.

U.S. Pat. No. 5,621,640 allows purchasers to use a card and to make a donation each time they make a purchase at any cash register. However, this requires the cooperation of any store. Also, the above mentioned patent specifically mentions that the invention is a means for making small donations.

U.S. Pat. No. 7,171,370 discloses that a funds distribution system is connected with point of sale transactions. This is for cash transactions.

U.S. Pat. No. 5,909,794—Donation transaction method and apparatus Donations in this patent are not tied to purchases.

Presently the credit cards there are vanity cards. With these cards, the credit card users use them and the card companies donate a percentage of each purchase to a specific charity, but the user receives no tax deduction, and typically does not get frequent flyer miles or other reward benefits card companies offer.

### SUMMARY

A method for using a credit or debit card for making a donation to a charity, may include the steps of selecting a charity for donations, selecting an amount for the donation based upon a purchase using the credit card and charging the credit card for the donation when the purchases are made.

The step of selecting the amount may include selecting a fixed percentage of the purchase price using the credit or debit card, and the step of selecting the amount may include the step of selecting of selecting a one time donation using a credit card.

The fixed percentage may be a fixed percentage of the purchase price, and the amount of donation may be based on the type of purchase with the credit or debit card.

The amount of donation may vary based upon the type of purchase with a credit or debit card. With the present invention, multiple charities may share from a fixed donation, and multiple charities may share based upon predetermined percentage of the donation. The donation may be tied to all purchases or may be a one-time donation. The charities selected for payment may be selected based upon a category of charities for example the category may have a specific purpose such as medical research or the category may be directed to a specific group of charities. Furthermore the charities may be randomly selected.

Furthermore, the credit or debit card user may be able to cancel a particular donation up to a specified time after a charge is made. At any time prior to a charge being made, a credit or debit card user may change the percentage or amount of donation to be given or the charity or charities to be the recipient of the donation or donations.

### BRIEF DESCRIPTION OF THE DRAWINGS

The invention may be understood by reference to the following taken in conjunction with the accompanying drawings, in which, like reference numerals identify like elements, and in which:

FIG. 1 shows a first portion of the steps of the present invention;

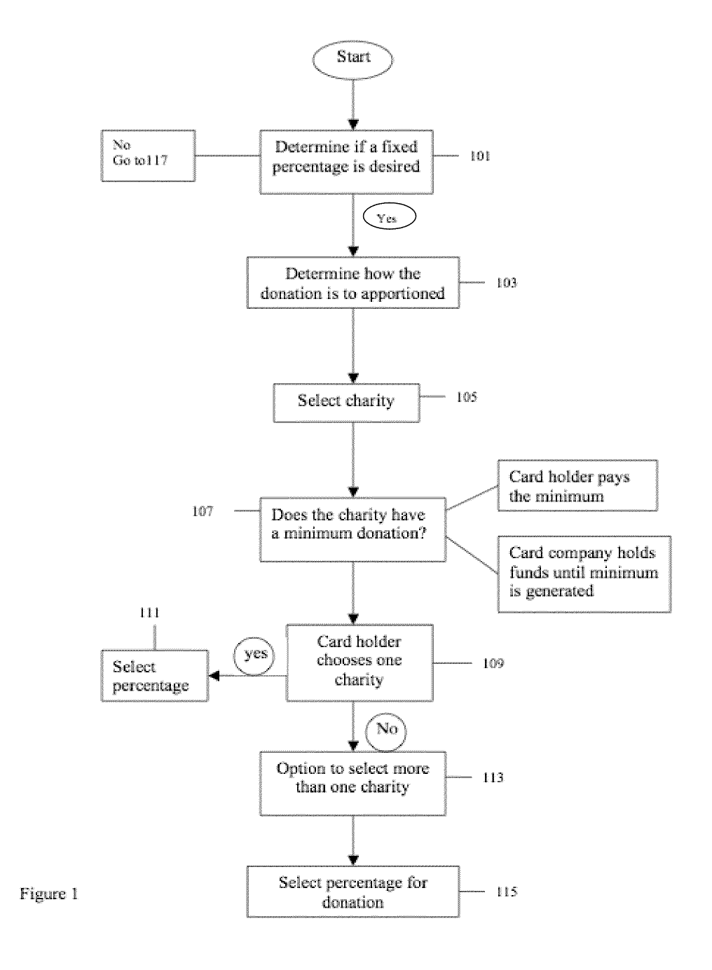

FIG. 2 such shows a second portion of the steps of the present invention.

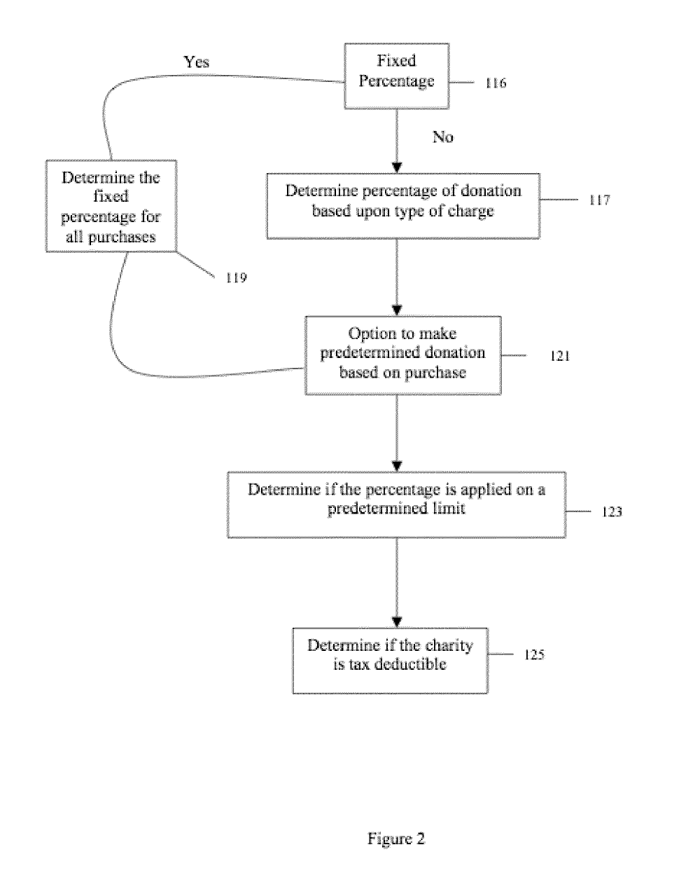

### BRIEF DESCRIPTION

Credit and debit card companies already have the technology to implement charges based upon certain types of purchases, i.e. Travel insurance. These charges do not have to be approved each time the credit card user uses that service.

The present invention takes advantage in part of existing technology, which is modified to achieve socially responsible results.

The present invention may be used in cooperation with a webpage which may allow the credit card user to pick and choose the charity/charities to be associated with purchase.

A credit or debit card user could make a tax deductible contribution based upon the percentage of the purchase price of the purchased item, or alternatively, the credit card user could make a tax-deductible contribution which may be a predetermined amount and may not vary regardless of the purchase price of the purchased item.

The present invention may include an apparatus and method for raising funds for a charitable organization using credit/debit card transactions. The present invention may be implemented on a computer such as a personal computer, a laptop, a pda, a cell phone, a blackberry or other similar devices. The present invention may generate money for charities in a way that was never used before. The present invention provides a way for credit or debit card users to tie some (or all) of their donations, to their spending.

Each credit/debit card holder will be able to go to their account either on the internet or by phone and click on a link enabling him to make charitable contributions in various ways. There, the credit card users may determine which charities to donate to and what percentage of their expenditures to donate or what flat fee the credit card users will donate to the charities. The credit card users may repeat this procedure for multiple charities in various ways, increasing giving, and lessening costs for charities of soliciting and obtaining funds.

For example if a credit card user has an account with American Express, the credit card user may be able to go to a specially designated link or telephone prompting which will ask him a series of questions to determine which charities will be the recipient of funds and how the funds will be donated.

The present invention can be used to donate a fixed percentage of each purchase the credit or debit card user makes to one or more charities in step 101. If so, the apportionment of the donations to a multitude of charities is determined in step 103. Credit or debit card users would have the option of designating their donations to any charity which is recognized as one for which tax deductible contributions can be made. The designation could be made from a pull down menu. Charities can be sorted in numerous ways: alphabetically, by location, by cause, by certain standards, etc. In step 105, the charity or charities are selected.

In step 107, it is determined if the charity will accept a minimum donation. If there is a minimum donation that can be accepted, that minimum would have to be recognized, and the charging institution could either hold funds until the minimum is generated, or credit card user can agree to make the minimum contribution. Credit or debit card users will be told what that minimum is before completing the registration.

If credit or debit card users would like to donate a fixed % to one charity in step 109, that charity will be selected, and the fixed % will be selected in step 111.

If a credit or debit card user would like to select several charities which will share the donation, first the credit or debit card user will select the charities in step 113. The credit or debit card user will then have the option of dividing the donation equally among those organizations, or selecting the % of his donation he wishes to give for each charity in step 115.

In step 116, it is determined if the credit card user wishes to donate a different percentage based upon a different type of purchase. If the response is yes, then step 119 is executed to determine the percentage for all the types of purchases.

If the response is no, then step 117 is executed. If the credit card user doesn't wish to donate a fixed percentage of each charge made to charity, then the percentage for each type of charge for which he wishes to make a donation will be determined in step 117. The credit card user would then be asked: would you like to donate different percentages of your charges, based upon the types of charges you make? The credit card user might not wish to make donations on necessary expenses i.e. Supermarket charges, but would wish to do so on restaurant charges.

A credit or debit card user could allocate, for example, 5% to go to a soup kitchen for every dollar spent eating out or purchasing food items, and 10% to a not-for-profit housing organization for every dollar charged for home improvements.

In step 121, it is determined if the credit or debit card user wishes to make a predetermined donation or a one time donation tied to a purchase. If a credit card user doesn't wish to have his purchases tied to a percentage for each time he makes a charge, the credit card user would be asked: would you like to make a one time donation tied to a purchase? If so, the credit card user may be given the options listed above. Or he may wish to make a fixed donation for particular types of charges. For example, he may elect to donate $1 to a given charity each time he eats out.

In step 123, the credit card user would determine if the percentage is only to be applied over a predetermined limit or up to a predetermined limit (for example, the credit card user could make a donation of 2% to a food pantry on supermarket charges up to $100 per visit, or the credit card user could make a donation on charges over $100.). A credit card user could also have the option of donating a % of a charge, or a % for a charge for any purchases made above a certain limit, or for certain types of charges made above a certain limit.

In step 125, the credit or debit card users would have the option of donating to any charity which is recognized as one for which tax deductible contributions can be made. If a charity that the credit card user desires is not available, the credit card user should be able to contact the credit/debit card company and have that charity included on their lists, provided that charity is a tax-deductible agency, within any geographical limits imposed by the credit/debit card company. The credit/debit card company may elect not to include certain types of charities at their discretion. It is not the donor's responsibility to determine if an organization is recognized by the IRS. However, donors should to be able to contact credit/debit card companies if a charitable organization he is interested in donating to is not on the list.

The credit card company/debit card company can elect to send donations as many times a year as desired, provided the agency complies with all legal requirements. The credit or debit card % costs can be waived or charged to the charity that normally get charged for credit or debit card donations. In addition, the credit card/debit card company can make money on the interest for the time it holds moneys that are donated.

Credit or debit card users would be able to change the % donated or the flat amount donated and the recipient charity(ies) at any time. Credit or debit card companies may allow credit or debit card users to reverse a donation, if they decide within a given period of time after a charge was made that a donation shouldn't be made for a specific charge.

Credit and debit card companies have the technology to implement charges based upon certain types of purchases, i.e. travel insurance. These charges do not have to be approved each time the credit card user uses that service. This present invention would take advantage of existing technology, implemented in a new, and socially responsible way. The charges once made are recorded on credit or debit card statements and the credit or debit card companies may itemize the contributions made by the credit or debit card user on a yearly basis in order to take advantage of income tax deductions.

The itemization of the contributions may be sent to the credit or debit card users via e-mail, but will always be seen on credit or debit card bill statements. In addition, charitable organizations will have to provide forms that are compliable with IRS regulations for donations exceeding a certain amount. Donors would have to agree to have their addresses provided to these charitable organizations by their credit or debit card companies in order to get these forms.

A non-limiting example is presented.

Charitable contribution allotment
1. Would you like to donate a percentage of all your expenses to a charity?

If yes, then select the %.
2. Would you like your donations to be to one charity?

If yes, then select from a drop down menu of charities.
3. If no, then would you like to equally divide your donations among various charities?

If yes, then select the number of charities.

Then select the charities.
4. If no, then would you like to donate differing percentages to different charities?

If yes, first select how many charities, then select the given charities, then select which % goes to which charity. The program will be hardwired to not allow more than 100% to be selected.
5. If no, to question 1, then would you like to tie donations to certain types of charges?

If yes, then choose from a drop down list of charge categories, i.e. Entertainment, travel, office, home improvement.

For each category, repeat questions 2-4 as needed. After completing the answer as to how a donation will be made to a given category, the credit or debit card user will be asked if he would like to make donations from other categories. This process will continue until either all categories are exhausted, or credit or debit card user determines he doesn't want to tie donations to any other expenses.

Credit or debit card users would have an option of donating a fixed amount to a charity or to several charities based upon individual purchases or based upon categories of purchases listed above.

They would also have the option of donating a fixed amount above a certain amount or a percentage of a purchase above a certain amount as detailed above: i.e. for supermarket charges above $100, he could elect to donate $5 per charge or 2% per cent per charge. Likewise, he could donate a percentage of charges up to a fixed amount: ie. 5% of all charges for home repair shops up to $500 per charge.
6. Credit or debit card users could be asked if they would like to make a one time donation to any charity, which would not be tied to purchases.
7. Credit card users who are uncertain of where to make donations, could allow the credit/debit card company to randomly select one charity, or to donate to a featured charity of the hour/month/week/whatever . . . Also, credit card users could elect to have their donations divided by a particular type of charity, i.e. Cancer research.
8. If a credit card user knows in advance that he will be making a particular charge that he wants to tie to a donation, he will have that option as well, and likewise, if there is a certain charge for which a credit card user doesn't wish to make a donation, a credit card user can indicate that as well.
9. There will be a page with links to all charities listed to enable credit card user to research different organizations.
10. Charities and credit/debit card companies could offer incentives for choosing certain charities. For example, some credit card companies double frequent flier miles given when donations are made through certain links.
11. Credit or debit card users will have the option of sharing their mailing address/email/phone info with charities they support. This is required if the credit or debit card user wishes to obtain a receipt for his donation(s).
12. After each selection, or in a place determined by the credit/debit card company, the credit/debit card user should initial agreement to whatever terms were selected. After completing how monies are to be donated, credit card users would be shown what they selected in a manner similar to this:

Dear Sir of Madam:

You have selected to make the following donations:

2% of all your entertainment charges to the Public Theatre.

5% of all your dining charges to the Covenant House

5% of all your travel charges to CanCare

5% of all your medical expenses to a combination of the following research organizations:

cancer, aids, diabetes etc.

10% of all your home improvement expenses to the Fuller Center for Housing

5% of all purchases over $25 for any individual purchase of books, to the Bedford Hills Library

10% for any clothing purchases over $50 to the Salvation Army

Thank you in advance for your generosity. If at any time you wish to change either the percentages you wish to donate, or the charities to which you wish to contribute, you may go to our website, log in, and do so.

Please initial that you approve of this description of your donations.

On behalf of those you help, we thank you for your generosity. Please tell your friends and families about this wonderful new way to help those less fortunate than ourselves.

Sincerely yours,

xxxxxx
13. At any time, credit or debit card user may cancel participation in this program.

For charges already made, the credit or debit card company may make their own policies. The present invention allows the credit or debit card users to change their minds until donations are made. The donor may request that the credit or debit card companies should not forward donations for a given number of days after a charge was made, giving credit or debit card users time to change their minds.
14. At any time, credit or debit card users may change either the charities to which donations will be made based upon his purchases, or the % s that will be donated, or the flat amounts that will be donated, or how the amounts to be donated are configured.
15. There are multiple ways questions could be asked about where to make donations, and alternative choices should not limit the present invention.
16. At the end of each month, there would be an itemization on the credit or debit card statement for all donations.
17. At the end of each year, charities would be responsible for sending letters acknowledging all contributions which are required to be acknowledged. In addition, the credit card/debit card company may itemize total donations on an annual basis as well. The credit card users may retain the right to withdraw the charitable contribution up to the point in time when the credit card company submits the charitable contribution to the charity. Alternatively, the credit card users may set a grace period with the credit card companies in order that the charitable contribution could be withdrawn and returned to the credit card user.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A method for using a credit or debit card for making a donation to a charity or charities, comprising the steps of:
selecting a charity or charities for donations;
selecting an amount for the donation based upon a purchase using the credit or debit card; charging the creditor debit card for the donation when the purchases are made.

2. A method for using a credit or debit card for making a donation to a charity or charities as in claim 1, wherein the step of selecting of the amount includes selecting a fixed percentage of the purchase price using the credit or debit card.

3. A method for using a credit or debit card for making a donation to a charity as in claim 1, wherein the step of selecting the amount includes the step of selecting a one time donation using a credit card.

4. A method for using a credit or debit card for making a donation to a charity or charities as in claim 2 wherein the fixed percentage is a fixed percentage of the purchase price.

5. A method for using a credit or debit card for making a donation to a charity as in claim 1, wherein the amount of donation is based on the type of purchase with the credit card.

6. A method for using a credit or debit card for making a donation to a charity as in claim 5, wherein the amount of donation varies based upon the type of purchase with a credit card.
